(19) United States
(12) Patent Application Publication
(10) Pub. No.: US 2013/0273934 A1
(43) Pub. Date: Oct. 17, 2013

(54) ADAPTIVE RADIO AREA NETWORK COVERAGE

(71) Applicants: Sheldon Meredith, Marietta, GA (US); Jeremy Fix, Acworth, GA (US); Mario Kosseifi, Roswell, GA (US)

(72) Inventors: Sheldon Meredith, Marietta, GA (US); Jeremy Fix, Acworth, GA (US); Mario Kosseifi, Roswell, GA (US)

(73) Assignee: AT&T MOBILITY II LLC, Atlanta, GA (US)

(21) Appl. No.: 13/447,072

(22) Filed: Apr. 13, 2012

(51) Int. Cl. H04W 64/00

(52) U.S. Cl. 455/456.1

(57) ABSTRACT

Adaptive radio area network (RAN) coverage is described. The azimuth, elevation or carrier-channel power of an antenna of a RAN can be adjusted to adapt the coverage area of the RAN. Monitoring scheduled and unscheduled changes in the characteristics of the coverage area can facilitate determining an adaptation response to adapt the coverage area. This can be performed in a closed-loop and can facilitate optimization of the coverage area with regard to predetermined optimization characteristics. UEs can be employed as mobile reporting components to measure coverage characteristics as a function of the position of the UE in the RAN. The UE can report measurements and the location information of the UE. The location information can be timed fingerprint location information.

### TECHNICAL FIELD

The disclosed subject matter relates to radio area network coverage and, more particularly, to adaptive radio area network coverage.

### BACKGROUND

By way of brief background, changing the coverage area for conventional radio area network (RAN) equipment, such as adjusting pitch and tilt of RAN antennas, has generally been a manually induced adjustment. As an example, a crew could be scheduled and dispatched to adjust an antenna elevation to improve interference levels with neighboring NodeB antennas.

### SUMMARY

The following presents a simplified summary of the disclosed subject matter in order to provide a basic understanding of some aspects of the various embodiments. This summary is not an extensive overview of the various embodiments. It is intended neither to identify key or critical elements of the various embodiments nor to delineate the scope of the various embodiments. Its sole purpose is to present some concepts of the disclosure in a streamlined form as a prelude to the more detailed description that is presented later.

In an embodiment, a system can include a processor and memory. The processor can facilitate the execution of computer-executable instructions stored on the memory. The execution of the computer-executable instructions can cause the processor to access RAN information for a change in a characteristic of the RAN coverage area. Based on the RAN information, the processor can further determine an adaptation response to facilitate adaptation of the coverage area of the RAN, wherein the adaptation response includes an adaptation of a characteristic of a RAN antenna. The processor can then facilitate access to the adaptation response.

In another embodiment, a method can include accessing, by a system, RAN information correlated to a change in a characteristic of the RAN coverage area. The method can further determine a set of correction factors to adapt the coverage area. The set of correction factors can include an adjustment of at least one parameter of a RAN antenna. The method can further facilitate access to the set of correction factors.

In a further embodiment, a mobile device can include a memory storing computer-executable instructions and a processor that facilitates execution of the computer-executable instructions. These instructions can cause the processor to determine timed fingerprint location information for a mobile device in a RAN. The processor can further determine a change in a characteristic of the RAN coverage area. A privacy policy can be applied, by the processor, to the location information and the change to form a set of privacy-protected information. The processor can then facilitate access to the privacy-protected information. Access can be facilitated for a remote computing component that facilitates adaptation of the RAN coverage area, including adaptation of a characteristic of a RAN antenna.

To the accomplishment of the foregoing and related ends, the disclosed subject matter, then, comprises one or more of the features hereinafter more fully described. The following description and the annexed drawings set forth in detail certain illustrative aspects of the subject matter. However, these aspects are indicative of but a few of the various ways in which the principles of the subject matter can be employed. Other aspects, advantages and novel features of the disclosed subject matter will become apparent from the following detailed description when considered in conjunction with the drawings.

### BRIEF DESCRIPTION OF DRAWINGS

FIG. 1 is an illustration of a system that facilitates adaptive radio area network coverage in accordance with aspects of the subject disclosure.

FIG. 2 is a depiction of a system that facilitates adaptive radio area network coverage by employing mobile reporting components, in accordance with aspects of the subject disclosure.

FIG. 3 illustrates a system that facilitates adaptive radio area network coverage, in view of scheduled and unscheduled network events, in accordance with the disclosed subject matter.

FIG. 4 is a depiction of a system that facilitates adaptive radio area network coverage in accordance with aspects of the subject disclosure.

FIG. 5 is a graphic of a plurality of exemplary adaptive radio area network coverage conditions in accordance with aspects of the subject disclosure.

FIG. 6 illustrates a method facilitating adaptive radio area network coverage in accordance with aspects of the subject disclosure.

FIG. 7 illustrates a method for facilitating adaptive radio area network coverage in accordance with aspects of the subject disclosure.

FIG. 8 illustrates a method for facilitating adaptive radio area network coverage in accordance with aspects of the subject disclosure.

FIG. 9 is a block diagram of an exemplary embodiment of a mobile network platform to implement and exploit various features or aspects of the subject disclosure.

FIG. 10 illustrates a block diagram of a computing system operable to execute the disclosed systems and methods in accordance with an embodiment.

### DETAILED DESCRIPTION

The subject disclosure is now described with reference to the drawings, wherein like reference numerals are used to refer to like elements throughout. In the following description, for purposes of explanation, numerous specific details are set forth in order to provide a thorough understanding of the subject disclosure. It may be evident, however, that the subject disclosure may be practiced without these specific details. In other instances, well-known structures and devices are shown in block diagram form in order to facilitate describing the subject disclosure.

Adjusting antenna coverage areas, such as by adjusting antenna down-tilt, azimuth, or carrier signal power levels, can be a less expensive way of adjusting radio area network (RAN) performance. Adjusting RAN performance can help optimize the operating efficiency of a wireless network. As an example, adjusting a first antenna to cover a smaller region and a neighboring antenna to cover a correspondingly larger region can effectively shift loading of the RAN from the first antenna to the neighboring antenna. This can help load balance a RAN. As a second example, where an unplanned outage of a base station occurs, adjusting nearby base station antennas can mitigate the effects of the outage. As a third example, scheduled based station service can be shifted to higher use times where nearby base stations can be adjusted to provide adequate coverage while the base station is being serviced.

Determining poor RAN coverage areas can facilitate adjustment of antenna coverage areas. NodeB in-service status can be monitored to determine outages, for example, to facilitate adjusting coverage areas to mitigate a planned or unplanned loss of a NodeB from the RAN. Loading on NodeBs can also be monitored, for example, to facilitate adjusting coverage areas to load balance. Further, integration with scheduling components can be employed, for example, to anticipate an outage and predetermine mitigating adjustments to antenna coverage areas. Historical information on loading patterns of a RAN can be employed, for example, to forecast use patterns and anticipatorily adjust antenna coverage areas. Moreover, mobile reporting components, e.g., user equipment (UE), can be used to track signal strength in coverage areas. This can help determine actual coverage area conditions at known locations. RAN coverage can be adapted based on the determined actual coverage area conditions at known locations. Mobile reporting components can facilitate determination of actual conditions at a known location by employing location determination technologies such as timed fingerprint location (TFL) or global positioning system (GPS) technologies.

TFL technologies can include location information or timing information as disclosed in more detail in U.S. Ser. No. 12/712,424 filed Feb. 25, 2010, which application is hereby incorporated by reference in its entirety. Further, such information can be accessed from active state or idle state user equipment as disclosed in more detail in U.S. Ser. No. 12/836,471, filed Jul. 14, 2010, which application is also hereby incorporated by reference in its entirety. As such, TFL information can facilitate access to location information for a mobile device, e.g., a UE, in an active or idle state. TFL information can be information from systems in a timed fingerprint location wireless environment, such as a TFL component of a wireless telecommunications carrier. As a non-limiting example, UEs, including mobile devices not equipped with a GPS-type system, can be associated with TFL information, which can facilitate determining a location for a UE based on the timing information associated with the UE.

In an aspect, TFL information can include information to determine a differential value for a NodeB site pair and a bin grid frame, as disclosed in more detail in incorporated U.S. Ser. No. 12/712,424. A centroid region (possible locations between any site pair) for an observed time value associated with any NodeB site pair (NBSP) can be calculated and is related to the determined value (in units of chip) from any pair of NodeBs. When UE time data is accessed, a value look-up can be initiated (e.g., a lookup for “DV(?,X)” as disclosed in more detail in the application incorporated herein by reference). Relevant NBSPs can be prioritized as part of the look-up. Further, the relevant pairs can be employed as an index to lookup a first primary set. As an example, time data for a UE can be accessed in relation to a locating event in a TFL wireless carrier environment. In this example, it can be determined that a NBSP, with a first reference frame, be used for primary set lookup with the computed DV(?,X) value as the index. This can for example return a set of bin grid frame locations forming a hyperbola between the NodeBs of the NBSP. A second lookup can then be performed for an additional relevant NBSP, with a second reference frame, using the same value DV(?,X), as an index into the data set. Continuing the example, the returned set for the look up with second NBSP can return a second set of bin grid frames. Thus, the UE is likely located in both sets of bin grid frames. Therefore, where the UE is likely in both sets, it is probable that the location for the UE is at an intersection of the two sets. Additional NBSPs can be included to further narrow the possible locations of the UE by providing additional intersections among relevant bin grid sets. As such, employing TFL information for location determination is demonstrably different from conventional location determination techniques or systems such as GPS, eGPS, triangulation or multilateration in wireless carrier environments, near field techniques, or proximity sensors.

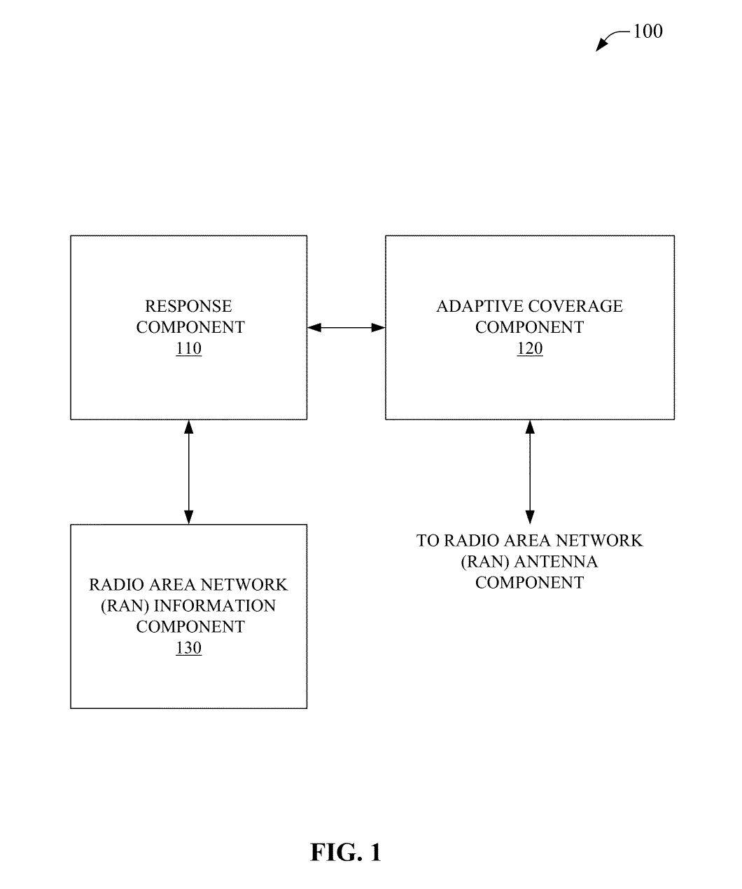

FIG. 1 is an illustration of a system 100, which facilitates adaptive radio area network coverage in accordance with aspects of the subject disclosure. System 100 can include response component 110. Response component 110 can determine an adaptation response to adapt RAN coverage. This can include adjustment of azimuth, elevation, or power levels of RAN equipment, including RAN antenna components. Further, an adaptation response can be for one or more RAN components, such as one or more antennas, one or more NodeBs, one or more RAN nodes, etc. Moreover, an adaptation response can include adaptations in response to trigger conditions. Trigger conditions can include temporal or event triggers. As an example, an adaptation response can include adapting a RAN coverage area at a particular time. As a second example, an adaptation response can include adapting a RAN coverage area in response to an event such as a load level meeting a predetermined condition, arrival of a service crew at a NodeB, etc. Response component 110 can be communicatively coupled with adaptive coverage component 120.

Adaptive coverage component 120 can access an adaptation response to facilitate adaptive RAN coverage. Adaptive coverage component 120 can apply at least a portion of the adaptation response to a RAN antenna component. As an example, where an adaptation response includes adaptations for a plurality of NodeB antennas, adaptive coverage component 120 can apply an adaption to the corresponding antenna. As a further example, where an adaptation response includes physical elevation adjustment of an antenna, adaptive coverage component can generate stepper motor controls and monitor positioning feedback to implement the physical elevation adjustment. Adaptive coverage component 120 can be an interface to a RAN antenna component to facilitate implementation of aspects of an adaptation response.

Response component 110 can be communicatively coupled with RAN information component 130. RAN information component 130 can facilitate access to RAN information. RAN information can include nearly any type of information that can be employed in determining an adaptation response of RAN equipment. For example, RAN information can include RAN equipment status, e.g., in-service or out-of-service, etc. As a further example, RAN information can include mobile reporting information, e.g., received signal strength indicator (RSSI) information, location information, etc. In still further examples, RAN information can include maintenance information, e.g., maintenance schedules, planned RAN component deployment schedules, etc. As another example, RAN information can include historical information that can be employed in predicting or forecasting RAN coverage events, e.g., historical loading of RAN equipment, historical impacts of events such as weather events, sporting events, political events, etc., historical adaptation response effects, etc. In an aspect, RAN information component 130 can aggregate RAN information. In a further aspect, RAN information component 130 can synthesize or filter RAN information to facilitate determination of an adaptation response. In yet another aspect, RAN information component 130 can include privacy features to facilitate safeguarding of private or personal information.

In an aspect, system 100 can be implemented in a closed-loop manner. As an example, a UE (not illustrated) can measure RSSI and location for the UE. This RSSI and location information can be aggregated by RAN information component 130. Response component 110 can access the aggregated RAN information by way of RAN information component 130. Response component 110 can determine an adaptation response based, at least in part, on the RSSI and location measurements from the UE. Adaptive coverage component 120 can access the adaptation response by way of response component 110. Adaptive coverage component 120 can implement at least a portion of the adaptation response, such as updating power level values for an array antenna near the location of the UE to adapt the coverage area of the array antenna. In response to the updated power levels for the array antenna, the coverage area of the array antenna can be adapted, such as increasing the coverage area. The increase in the coverage area can be associated with better coverage of the location of the UE. The UE can again measure the RSSI and location for the UE, reflecting the adapted coverage area. These new UE measurements can again be included in adapting the coverage area. As such, closed-loop adaptive control of RAN coverage area can be readily implemented.

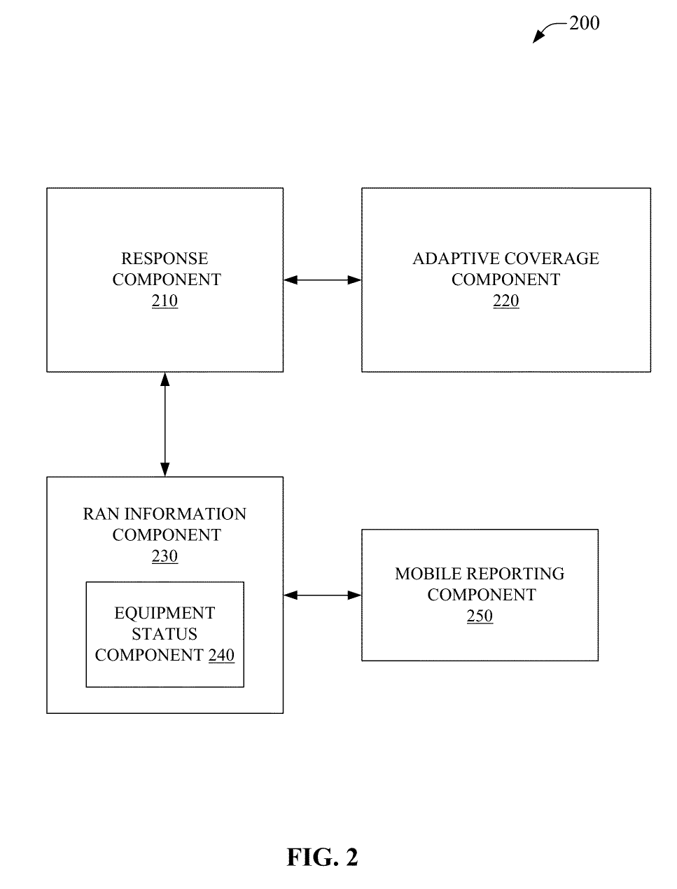

FIG. 2 is a depiction of a system 200 that can facilitate adaptive radio area network coverage by employing mobile reporting components, in accordance with aspects of the subject disclosure. System 200 can include response component 210. Response component 210 can determine an adaptation response to adapt RAN coverage. This can include adjustment of azimuth, elevation, or power levels of RAN equipment, including RAN antenna components. Response component 210 can be communicatively coupled with adaptive coverage component 220. Adaptive coverage component 220 can access an adaptation response to facilitate adaptive RAN coverage. Adaptive coverage component 220 can apply at least a portion of the adaptation response to a RAN component(s). Response component 210 can be communicatively coupled with RAN information component 230. RAN information component 230 can facilitate access to RAN information. RAN information can include nearly any type of information that can be employed in determining an adaptation response of RAN equipment. In an aspect, RAN information component 230 can aggregate RAN information. In a further aspect, RAN information component 230 can synthesize or filter RAN information to facilitate determination of an adaptation response. In yet another aspect, RAN information component 230 can include privacy features to facilitate safeguarding of private or personal information.

RAN information component 230 can include equipment status component 240. Equipment status component 240 can facilitate access to RAN equipment status information. RAN equipment status information can include historical, current, and future RAN equipment status information. As an example, RAN information can include current RAN equipment status, e.g., in-service or out-of-service. In another example, RAN information can include future RAN equipment status information, such as planned maintenance schedules (e.g., future outages), anticipated RAN component deployment schedules (e.g., future in-service areas), etc. As a further example, RAN information can include historical RAN equipment status information, such as previous outages, historic load patterns, etc. Further, while equipment status component 240 is illustrated as being included in RAN information component 230, other embodiments are not so limited and equipment status component 240 can be a local component, remote component, or a distributed component.

RAN information component 230 can be communicatively coupled to mobile reporting component 250. Mobile reporting component 250 can include mobile devices that can facilitate access to RAN information related to the mobile device. As an example, RAN information can include mobile reporting information, e.g., received signal strength indicator (RSSI) information, location information, etc. In an aspect, mobile reporting component 250 can be a UE. In other aspects, mobile reporting component 250 can be stationary, e.g., a mobile component capable of being moved but not in movement, or non-stationary, such as a UE in a moving vehicle, etc. As such, an exemplary mobile reporting component 250, such as a laptop computer that is stationary, for example, being located on a desk in an office environment, can facilitate access to RAN information. Continuing the laptop example, the laptop can measure location and RSSI strength by way of a RAN adapter and can facilitate access to this information, such as by way of the RAN adapter, by way of a wireless LAN adapter, e.g., an 802.11-type adapter, or by way of a wired network adapter, e.g., Ethernet, etc. In another example, a smartphone can report RSSI and location information by way of a RAN while the smartphone is in motion.

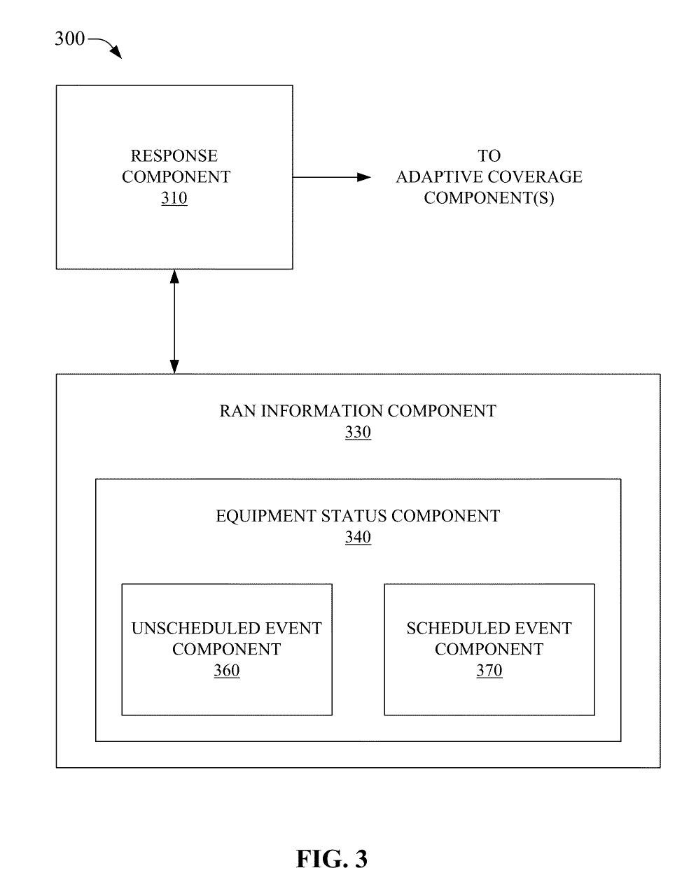

FIG. 3 illustrates a system 300 that facilitates adaptive radio area network coverage, in view of scheduled and unscheduled network events, in accordance with aspects of the subject disclosure. System 300 can include response component 310. Response component 310 can determine an adaptation response to adapt RAN coverage areas. This can include adjustment of azimuth, elevation, or power levels of RAN equipment, including RAN antenna components. Response component 310 can facilitate access an adaptation response to facilitate adaptive RAN coverage, such as by way of an adaptive coverage component(s) that can apply at least a portion of the adaptation response to a RAN component(s). Response component 310 can be communicatively coupled with RAN information component 330. RAN information component 330 can facilitate access to RAN information. RAN information can include nearly any type of information that can be employed in determining an adaptation response of RAN equipment. In an aspect, RAN information component 330 can aggregate RAN information. In a further aspect, RAN information component 330 can synthesize or filter RAN information to facilitate determination of an adaptation response. In yet another aspect, RAN information component 330 can include privacy features to facilitate safeguarding of private or personal information.

RAN information component 330 can include equipment status component 340. Equipment status component 340 can facilitate access to RAN equipment status information. RAN equipment status information can include historical, current, and future RAN equipment status information. Further, while equipment status component 340 is illustrated as being included in RAN information component 330, other embodiments are not so limited and equipment status component 340 can be a local component, remote component, or a distributed component.

Equipment status component 340 can further include unscheduled event component 360. Unscheduled event component 360 can facilitate access to unscheduled RAN event information. Unscheduled RAN even information can include unscheduled NodeB outages, non-predictive loading conditions, mobile reporting component measurements, etc. As an example, a power outage can force a NodeB to go offline. The offline status of the NodeB can be accessed by way of unscheduled event component 360. Further, information relating to lost coverage area due to the offline status of the NodeB can be accessed by way of unscheduled event component 360, such as by way of reports from UEs, historical information relating to prior outages of the NodeB, simulation results of an outage of the NodeB, etc.

Equipment status component 340 can also include scheduled event component 370. Scheduled event component 370 can facilitate access to scheduled RAN event information. Scheduled RAN event information can include scheduled NodeB outages, such as schedules maintenance. Scheduled RAN event information can further include forecast RAN coverage conditions, for example, anticipated loading conditions based on historical patterns, etc. In an aspect, scheduled event component 370 can access information related to scheduled RAN coverage by way of other systems, for example, maintenance schedules on a contracted service provider's servers, predictive UE traffic models by way of a remote vendor system, etc.

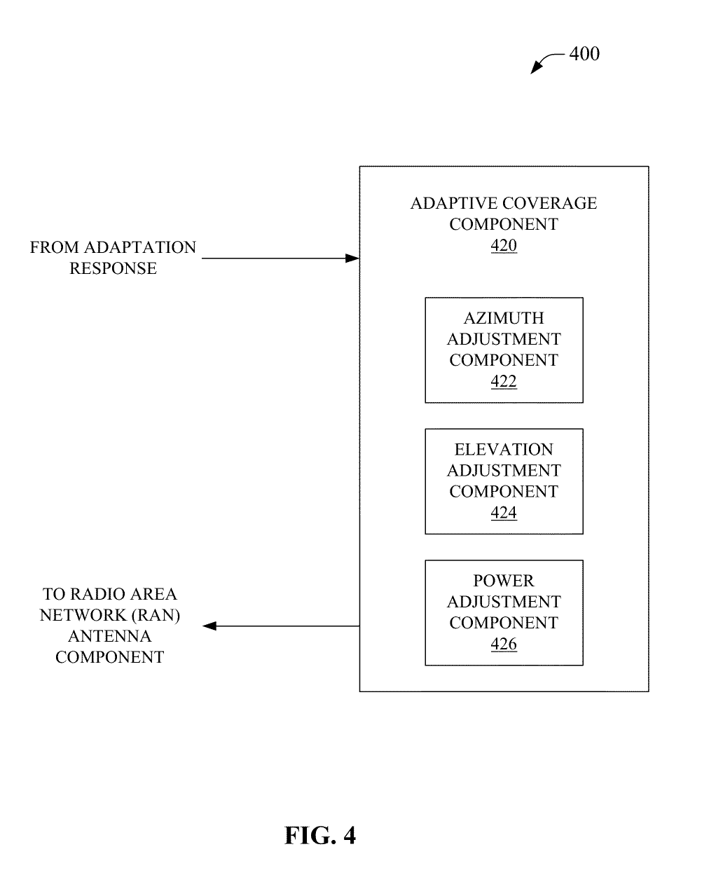

FIG. 4 is a depiction of a system 400 that facilitates adaptive radio area network coverage in accordance with aspects of the subject disclosure. System 400 can include adaptive coverage component 420. Adaptive coverage component 420 can access an adaptation response to facilitate adaptive RAN coverage. Adaptive coverage component 220 can apply at least a portion of the adaptation response to a RAN component(s), which can include RAN antenna component(s). Adaptive coverage component 420 can include azimuth adjustment component 422, elevation adjustment component 424, and/or power adjustment component 426.

Azimuth adjustment component 422 can facilitate azimuth adjustment of a RAN antenna component(s) as part of adaptation of a RAN coverage area. In an aspect, azimuth adjustment can include mechanical adjustment of an antenna azimuth. In a further aspect, azimuth adjustment can include beam shaping that adjusts the effective projection angle for coverage of an antenna.

Elevation adjustment component 424 can facilitate elevation adjustment of a RAN antenna component(s) as part of adaptation of a RAN coverage area. In an aspect, elevation adjustment can include mechanical adjustment of an antenna elevation and the corresponding coverage horizon. In a further aspect, elevation adjustment can include electronic adjustment of an antenna to adjust the coverage horizon without necessarily mechanically adjusting the tilt of the antenna, for example, adjusting the transmit power for a portion of an antenna array relative another portion of the antenna array resulting in a change in the area of coverage for the antenna array.

Power adjustment component 426 can facilitate carrier signal power adjustment for a RAN antenna component(s) as part of adaptation of a RAN coverage area. In an aspect, power can be adjusted to adjust coverage area size, for example, increasing power to cover a larger area. In another aspect, power can be adjusted to adjust coverage area quality, for example, by lowering power to reduce interference with anther NodeB.

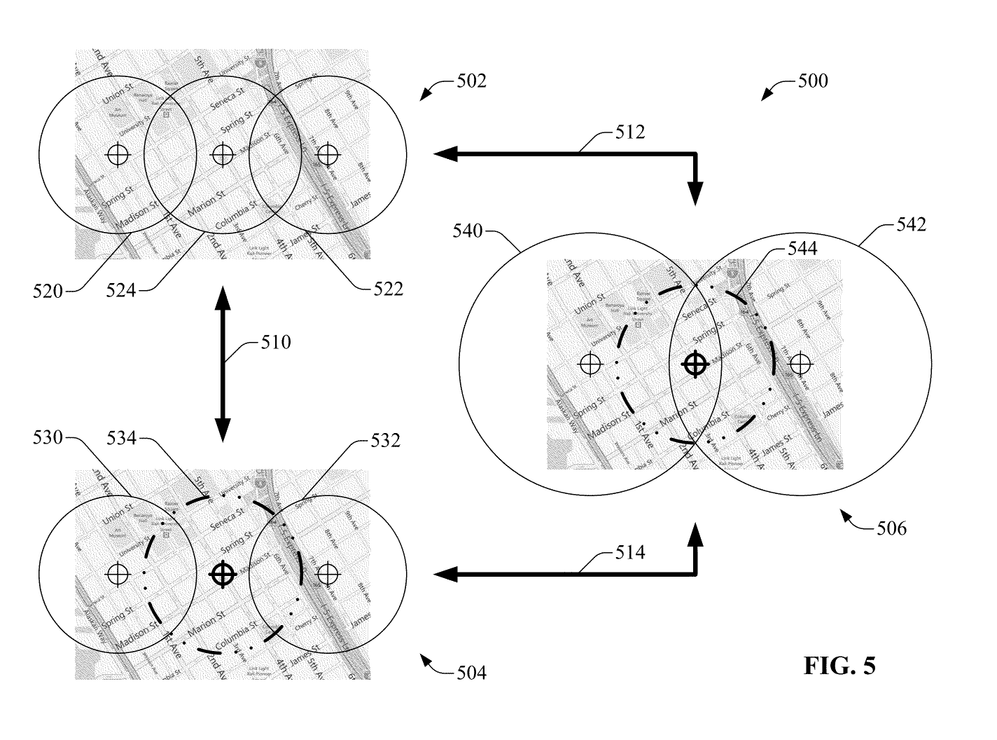

FIG. 5 is a graphic 500 of a plurality of exemplary adaptive radio area network coverage states 502, 504, 506, in accordance with aspects of the subject disclosure. Exemplary adaptive radio area network coverage state 502 illustrates three RAN components with corresponding coverage areas 520, 522, and 524, superimposed over a map. Coverage areas 520-524 can correspond to in-service NodeBs and thus can be associated with areas of in-service coverage. As such, UEs within the coverage areas, e.g., 520-524, can have access to a wireless network by way of the corresponding RAN components.

Exemplary adaptive radio area network coverage state 504 illustrates three RAN components with corresponding coverage areas 530, 532, and 534, superimposed over a map. In contrast to exemplary adaptive radio area network coverage state 502, coverage area 534 can correspond to an out-of-service NodeB and thus coverage area 534 can be associated with an area of out-of-service coverage as represented by the dot-dot-dash broken line. Coverage areas 530 and 532 can correspond to in-service NodeBs and thus can be associated with areas of in-service coverage. UEs within the coverage areas 530 and 532 can have access to a wireless network by way of the corresponding RAN components while UEs within coverage area 534, and not within 530 or 532, would not likely have access to the wireless network.

Exemplary adaptive radio area network coverage state 506 illustrates three RAN components with corresponding coverage areas 540, 542, and 544, superimposed over a map. Similar to exemplary adaptive radio area network coverage state 504, coverage area 544 can correspond to an out-of-service NodeB and thus coverage area 544 can be associated with an area of out-of-service coverage as represented by the dot-dot-dash broken line. Coverage areas 540 and 542 can correspond to in-service NodeBs and thus can be associated with areas of in-service coverage. UEs within the coverage areas 540 and 542 can have access to a wireless network by way of the corresponding RAN components. Wherein coverage areas 540 and 542 eclipse coverage area 544, UEs within coverage area 544, would also likely have access to the wireless network by way of their also being within the coverage areas 540 and 542.

In an aspect, exemplary adaptive radio area network coverage states 502 and 506 can illustrate adaptive radio area network coverage in accordance with aspects of the subject disclosure by way of transitions between states 510, 512, and 514. As an example, exemplary adaptive radio area network coverage state 502 can represent a starting RAN condition wherein the several NodeBs and corresponding coverage areas 520-524 are in-service and providing wireless network coverage to UEs. A transition 510 to exemplary adaptive radio area network coverage state 504 can occur when the NodeB and corresponding service area 524 goes out-of-service, wherein service area 520 would map to service area 530, service area 522 would map to service area 532, and service area 524 would map to service area 534, with service areas 530-532 remaining in-service and service area 534 transitioning to out-of-service. Such a transition can be due to planned or unplanned conditions as discussed previously.

Exemplary adaptive radio area network coverage state 504 can represent a suboptimal RAN coverage condition due to the lack of coverage in portions of service area 534 not otherwise covered by service areas 530 and 532. UEs across the several service areas 530-534 can measure the changes in the service areas due to transition 510. In response, systems and methods in accordance with those disclosed herein can adapt the RAN coverage area to mitigate the effects of transition 510 from service area 524 to service area 534. Transition 514 can be correlated with adapting the RAN coverage area between exemplary adaptive radio area network coverage states 504 and 506. Transition 514 to exemplary adaptive radio area network coverage state 506 can occur when the NodeBs corresponding to service areas 530 and 532 adapt to cover a larger area, and wherein service area 530 would map to service area 540, service area 532 would map to service area 542, and service area 534 would map to service area 544, with service areas 540-542 remaining in-service and service area 544 remaining out-of-service. Exemplary adaptive radio area network coverage state 506 can illustrate that service areas 540 and 542 effectively provide service to the region formerly served by service area 544.

Transition 512 can be correlated with adapting the RAN coverage area between exemplary adaptive radio area network coverage states 506 and 502. Transition 512 to exemplary adaptive radio area network coverage state 502 from 506 can occur when the NodeBs corresponding to service areas 540 and 542 adapt to cover a smaller area, and wherein service area 540 would map to service area 520, service area 542 would map to service area 522, and service area 54 would map to service area 524, with service areas 520-522 remaining in-service and service area 524 transitioning to in-service. Exemplary adaptive radio area network coverage state 502 can illustrate that service areas 540 and 542 can be reduced when coverage area 524 provides redundant coverage to the region formerly served by service area 544.

It will be noted that transitions 510, 512, and 514 can occur in either direction. However, for clarity and brevity, transitions discussed herein are generally limited to the transition order from state 502 to state 504, then to state 506, and again to state 502. These transitions can correspond to loss of a NodeB (transition 502 to 504), adaptation of the RAN coverage area to mitigate the loss of the NodeB (transition 504 to 506), return to service of the NodeB and adaptation of the RAN coverage area in response to the return of the NodeB (transition 506 to 502). It will further be noted that while service areas in graphic 500 are generally circular for simplicity of illustration, other embodiments of the disclosed subject matter are not so limited and all coverage area shapes are within the scope of the present disclosure.

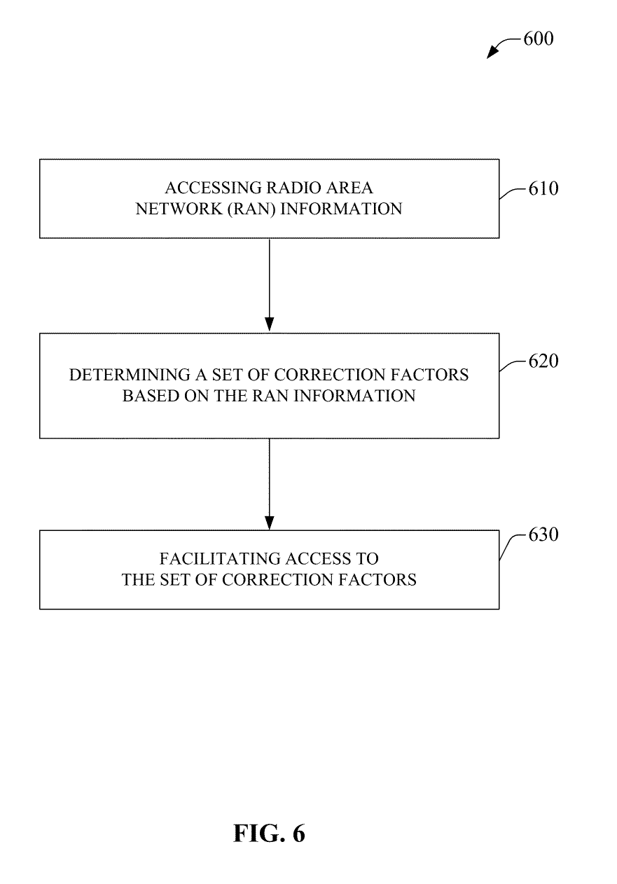

In view of the example system(s) described above, example method(s) that can be implemented in accordance with the disclosed subject matter can be better appreciated with reference to flowcharts in FIG. 6-FIG. 8. For purposes of simplicity of explanation, example methods disclosed herein are presented and described as a series of acts; however, it is to be understood and appreciated that the claimed subject matter is not limited by the order of acts, as some acts may occur in different orders and/or concurrently with other acts from that shown and described herein. For example, one or more example methods disclosed herein could alternatively be represented as a series of interrelated states or events, such as in a state diagram. Moreover, interaction diagram(s) may represent methods in accordance with the disclosed subject matter when disparate entities enact disparate portions of the methods. Furthermore, not all illustrated acts may be required to implement a described example method in accordance with the subject specification. Further yet, two or more of the disclosed example methods can be implemented in combination with each other, to accomplish one or more aspects herein described. It should be further appreciated that the example methods disclosed throughout the subject specification are capable of being stored on an article of manufacture (e.g., a computer-readable medium) to allow transporting and transferring such methods to computers for execution, and thus implementation, by a processor or for storage in a memory.

FIG. 6 illustrates aspects of a method 600 facilitating adaptive radio area network coverage in accordance with aspects of the subject disclosure. At 610, radio area network (RAN) information can be accessed. RAN information can include nearly any type of information that can be employed in determining an adaptation response of RAN equipment. For example, RAN information can include RAN equipment status, e.g., in-service or out-of-service, etc. As a further example, RAN information can include mobile reporting information, e.g., received signal strength indicator (RSSI) information, location information, etc. In still further examples, RAN information can include maintenance information, e.g., maintenance schedules, planned RAN component deployment schedules, etc. As another example, RAN information can include historical information that can be employed in predicting or forecasting RAN coverage events, e.g., historical loading of RAN equipment, historical impacts of events such as weather events, sporting events, political events, etc., historical adaptation response effects, etc. In an aspect, RAN information can be aggregated RAN information. In a further aspect, RAN information can be synthesized or filtered RAN information. In yet another aspect, RAN information can include RAN information subject to privacy features to facilitate safeguarding of private or personal information.

At 620, a set of correction factors based on the RAN information can be determined. The set of correction factors can be employed to adapt RAN coverage. Adapting RAN coverage can include adjustment of azimuth, elevation, or power levels of RAN equipment, including RAN antenna components. Further, a set of correction factors can be for adapting one or more RAN components, such as one or more antennas, one or more NodeBs, one or more RAN nodes, etc. Moreover, a set of correction factors can include adaptations in response to trigger conditions. Trigger conditions can include temporal or event triggers. As an example, an adaptation response can include adapting a RAN coverage area at a particular time. As a further example, an adaptation response can include adapting a RAN coverage area in response to an event such as an interference level meeting a predetermined condition, etc. It will be noted that a set of correction factors can include some, many, or no correction factors (e.g., an empty set).

At 630, access to the set of correction factors can be facilitated. At this point, method 600 can end. As an example, a component, such as adaptive coverage component 120, can access a set of correction factors to facilitate adaptive RAN coverage. The component can apply the set of correction factors to a RAN antenna. As an example, where the set of correction factors includes adaptations for a plurality of NodeB antennas, a component can apply adaptations to the corresponding antenna. As a further example, where the set of correction factors includes physical elevation adjustment of an antenna, the component can generate stepper motor controls and monitor positioning feedback to implement the physical elevation adjustment. The component can be an interface to a RAN antenna component to facilitate implementation of aspects of the set of correction factors.

Method 600 can provide for closed-loop adaptation of RAN coverage area. As an example, a UE can measure RSSI and location for the UE. This RSSI and location information can be accessed, e.g., at 610. A set of correction factors can be determine, e.g., at 620, based on the RSSI and location information from the UE. RAN components can be given access to the set of correction factors, e.g., at 630 determined from the UE information. In an aspect, this accessed set of correction factors can implement adaptation of the RAN coverage area by adjusting parameters of RAN components, such as updating power level values for an array antenna near the location of the UE to adapt the coverage area of the array antenna. In response to the updated power levels for the array antenna, the coverage area of the array antenna can be adapted, such as increasing the coverage area. The increase in the coverage area can be associated with better coverage of the location of the UE. The UE can again measure the RSSI and location for the UE, reflecting the adapted coverage area. These new UE measurements can again be included in adapting the coverage area. As such, closed-loop adaptive control of RAN coverage area can be readily implemented, at least in part, by way of method 600.

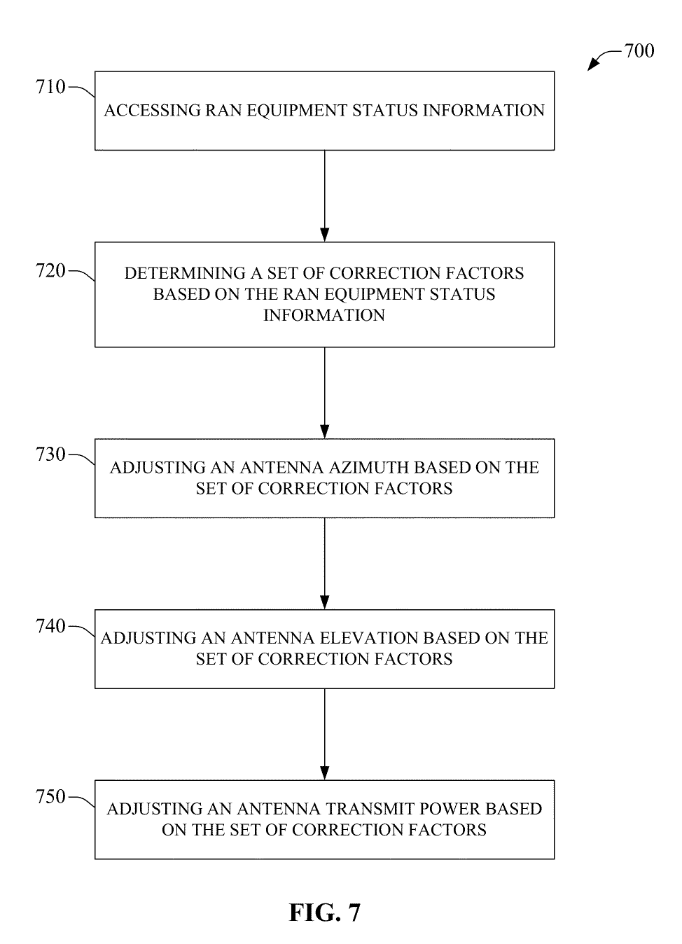

FIG. 7 illustrates a method 700 that facilitates adaptive radio area network coverage in accordance with aspects of the subject disclosure. At 710, RAN equipment information can be accessed. RAN equipment information can include nearly any type of information that can be employed in an adaptation of RAN coverage area. RAN equipment information can include RAN equipment status, mobile device reporting information, maintenance information, historical information that can be employed in predicting or forecasting RAN coverage events, etc. RAN equipment information can be aggregated RAN information, synthesized or filtered RAN information, or privacy protected information safeguarding private or personal information. At 720, a set of correction factors based on the RAN equipment information can be determined. The set of correction factors can be employed to adapt RAN coverage. Adapting RAN coverage can include adjustment of azimuth, elevation, or power levels of RAN equipment, including RAN antenna components. Moreover, a set of correction factors can include adaptations in response to trigger conditions.

At 730, a RAN antenna azimuth can be adjusted based on the set of correction factors. Azimuth adjustment of a RAN antenna can be part of adaptation of a RAN coverage area. In an aspect, azimuth adjustment can include mechanical adjustment of an antenna azimuth. In a further aspect, azimuth adjustment can include beam shaping that adjusts the effective projection angle for coverage of an antenna.

At 740, a RAN antenna elevation can be adjusted based on the set of correction factors. Elevation adjustment of a RAN antenna can be part of adaptation of a RAN coverage area. In an aspect, elevation adjustment can include mechanical adjustment of an antenna elevation and the corresponding coverage horizon. In a further aspect, elevation adjustment can include electronic adjustment of an antenna to adjust the coverage horizon without necessarily mechanically adjusting the tilt of the antenna, for example, adjusting the transmit power for a portion of an antenna array relative another portion of the antenna array resulting in a change in the area of coverage for the antenna array.

At 750, a RAN antenna power can be adjusted based on the set of correction factors. At this point, method 700 can end. Power adjustment of a RAN antenna can be part of adaptation of a RAN coverage area. In an aspect, power can be adjusted to adjust coverage area size, for example, increasing power to cover a larger area. In another aspect, power can be adjusted to adjust coverage area quality, for example, by lowering power to reduce interference with anther NodeB.

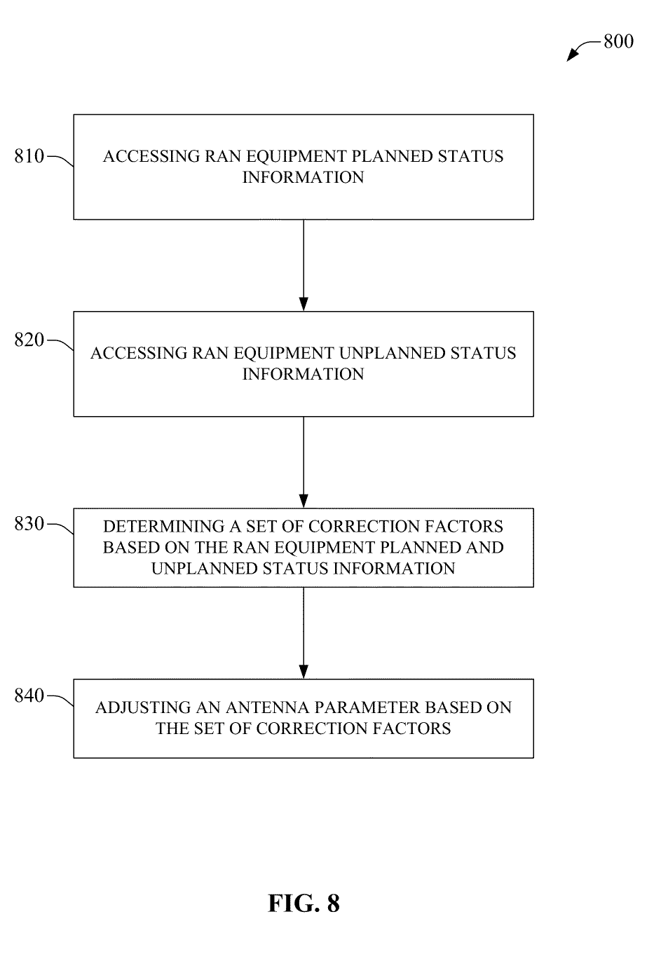

FIG. 8 illustrates a method 800 that facilitates adaptive radio area network coverage in accordance with aspects of the subject disclosure. At 810, RAN equipment planned status information can be accessed. RAN equipment planned status information can include nearly any type of information that can be employed in an adaptation of RAN coverage area. RAN equipment planned status information can include planned NodeB outages, such as planned maintenance. RAN equipment planned status information can further include forecast RAN coverage conditions, for example, anticipated loading conditions based on historical patterns, etc. In an aspect, RAN equipment planned status information related to scheduled RAN coverage can be accessed by way of other systems, for example, maintenance schedules on a contracted service provider's servers, predictive UE traffic models by way of a remote vendor system, etc. RAN equipment planned status information can be aggregated RAN information, synthesized or filtered RAN information, or privacy protected information safeguarding private or personal information.

At 820, RAN equipment unplanned status information can be accessed. RAN equipment unplanned status information can include nearly any type of information that can be employed in an adaptation of RAN coverage area. RAN equipment unplanned status information can include unplanned NodeB outages, non-predictive loading conditions, mobile reporting component measurements, etc. As an example, a power outage can force a NodeB to go offline. The offline status of the NodeB can be accessed as RAN equipment unplanned status information. Further, information relating to lost coverage area due to the offline status of the NodeB can be accessed, for example, by way of reports from UEs, historical information relating to prior outages of the NodeB, simulation results of an outage of the NodeB, etc. RAN equipment unplanned status information can be aggregated RAN information, synthesized or filtered RAN information, or privacy-protected information safeguarding private or personal information.

At 830, a set of correction factors based on the RAN planned and unplanned equipment information can be determined. The set of correction factors can be employed to adapt RAN coverage. Adapting RAN coverage can include adjustment of azimuth, elevation, or power levels of RAN equipment, including RAN antenna components. Moreover, a set of correction factors can include adaptations in response to trigger conditions.

At 840, a RAN antenna can be adjusted based on the set of correction factors. At this point, method 800 can end. Adjustment of a RAN antenna can be part of adaptation of a RAN coverage area. This can include adjustment of azimuth, elevation, or power levels of the RAN antenna. In an aspect, antenna adjustment can include mechanical adjustment of an antenna. In a further aspect, adjustment can include electronic adjustment of an antenna without necessarily mechanically adjusting the antenna, for example, adjusting the transmit power for a portion of an antenna array relative another portion of the antenna array can result in a change in the area of coverage for the antenna array.

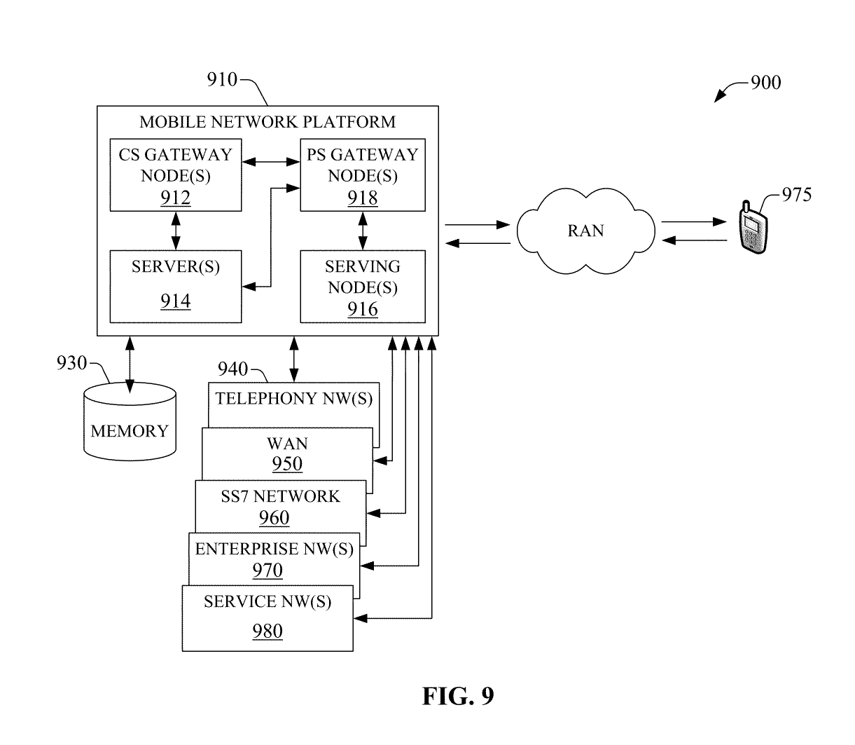

FIG. 9 presents an example embodiment 900 of a mobile network platform 910 that can implement and exploit one or more aspects of the disclosed subject matter described herein. Generally, wireless network platform 910 can include components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, wireless network platform 910 can be included in telecommunications carrier networks, and can be considered carrier-side components as discussed elsewhere herein. Mobile network platform 910 includes CS gateway node(s) 912 which can interface CS traffic received from legacy networks like telephony network(s) 940 (e.g., public switched telephone network (PSTN), or public land mobile network (PLMN)) or a signaling system #7 (SS7) network 970. Circuit switched gateway node(s) 912 can authorize and authenticate traffic (e.g., voice) arising from such networks. Additionally, CS gateway node(s) 912 can access mobility, or roaming, data generated through SS7 network 970; for instance, mobility data stored in a visited location register (VLR), which can reside in memory 930. Moreover, CS gateway node(s) 912 interfaces CS-based traffic and signaling and PS gateway node(s) 918. As an example, in a 3GPP UMTS network, CS gateway node(s) 912 can be realized at least in part in gateway GPRS support node(s) (GGSN). It should be appreciated that functionality and specific operation of CS gateway node(s) 912, PS gateway node(s) 918, and serving node(s) 916, is provided and dictated by radio technology(ies) utilized by mobile network platform 910 for telecommunication.

In addition to receiving and processing CS-switched traffic and signaling, PS gateway node(s) 918 can authorize and authenticate PS-based data sessions with served mobile devices. Data sessions can include traffic, or content(s), exchanged with networks external to the wireless network platform 910, like wide area network(s) (WANs) 950, enterprise network(s) 970, and service network(s) 980, which can be embodied in local area network(s) (LANs), can also be interfaced with mobile network platform 910 through PS gateway node(s) 918. It is to be noted that WANs 950 and enterprise network(s) 960 can embody, at least in part, a service network(s) like IP multimedia subsystem (IMS). Based on radio technology layer(s) available in technology resource(s) 917, packet-switched gateway node(s) 918 can generate packet data protocol contexts when a data session is established; other data structures that facilitate routing of packetized data also can be generated. To that end, in an aspect, PS gateway node(s) 918 can include a tunnel interface (e.g., tunnel termination gateway (TTG) in 3GPP UMTS network(s) (not shown)) which can facilitate packetized communication with disparate wireless network(s), such as Wi-Fi networks.

In embodiment 900, wireless network platform 910 also includes serving node(s) 916 that, based upon available radio technology layer(s) within technology resource(s) 917, convey the various packetized flows of data streams received through PS gateway node(s) 918. It is to be noted that for technology resource(s) 917 that rely primarily on CS communication, server node(s) can deliver traffic without reliance on PS gateway node(s) 918; for example, server node(s) can embody at least in part a mobile switching center. As an example, in a 3GPP UMTS network, serving node(s) 916 can be embodied in serving GPRS support node(s) (SGSN).

For radio technologies that exploit packetized communication, server(s) 914 in wireless network platform 910 can execute numerous applications that can generate multiple disparate packetized data streams or flows, and manage (e.g., schedule, queue, format . . . ) such flows. Such application(s) can include add-on features to standard services (for example, provisioning, billing, customer support . . . ) provided by wireless network platform 910. Data streams (e.g., content(s) that are part of a voice call or data session) can be conveyed to PS gateway node(s) 918 for authorization/authentication and initiation of a data session, and to serving node(s) 916 for communication thereafter. In addition to application server, server(s) 914 can include utility server(s), a utility server can include a provisioning server, an operations and maintenance server, a security server that can implement at least in part a certificate authority and firewalls as well as other security mechanisms, and the like. In an aspect, security server(s) secure communication served through wireless network platform 910 to ensure network's operation and data integrity in addition to authorization and authentication procedures that CS gateway node(s) 912 and PS gateway node(s) 918 can enact. Moreover, provisioning server(s) can provision services from external network(s) like networks operated by a disparate service provider; for instance, WAN 950 or Global Positioning System (GPS) network(s) (not shown). Provisioning server(s) can also provision coverage through networks associated to wireless network platform 910 (e.g., deployed and operated by the same service provider), such as femto-cell network(s) (not shown) that enhance wireless service coverage within indoor confined spaces and offload RAN resources in order to enhance subscriber service experience within a home or business environment by way of UE 975.

It is to be noted that server(s) 914 can include one or more processors configured to confer at least in part the functionality of macro network platform 910. To that end, the one or more processor can execute code instructions stored in memory 930, for example. It is should be appreciated that server(s) 914 can include a content manager 915, which operates in substantially the same manner as described hereinbefore.

In example embodiment 900, memory 930 can store information related to operation of wireless network platform 910. Other operational information can include provisioning information of mobile devices served through wireless platform network 910, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 930 can also store information from at least one of telephony network(s) 940, WAN 950, enterprise network(s) 960, or SS7 network 970. In an aspect, memory 930 can be, for example, accessed as part of a data store component or as a remotely connected memory store.

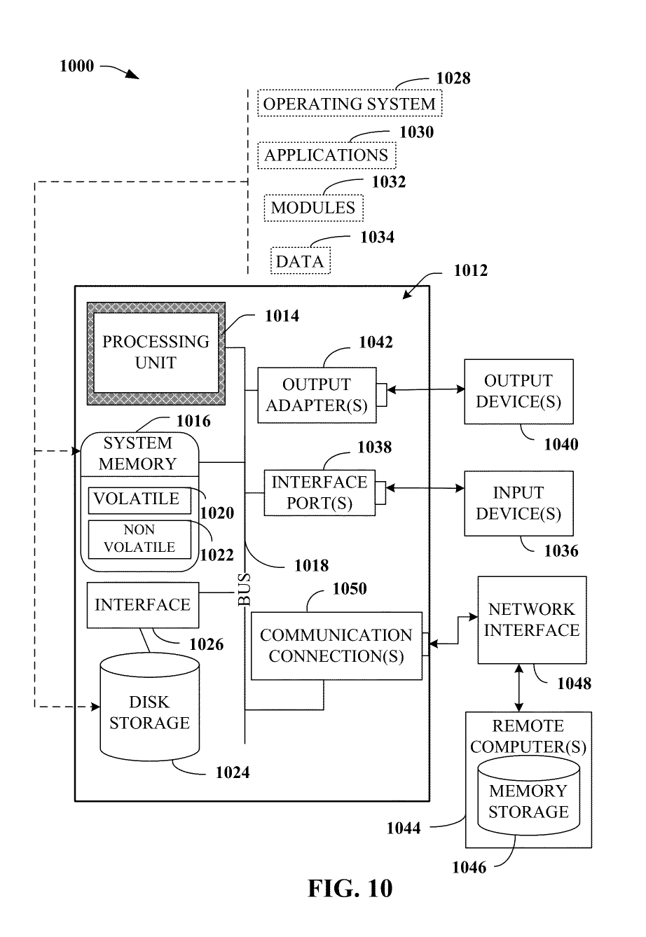

In order to provide a context for the various aspects of the disclosed subject matter, FIG. 10, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules include routines, programs, components, data structures, etc. that perform particular tasks and/or implement particular abstract data types.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can include both volatile and nonvolatile memory, by way of illustration, and not limitation, volatile memory 1020 (see below), non-volatile memory 1022 (see below), disk storage 1024 (see below), and memory storage 1046 (see below). Further, nonvolatile memory can be included in read only memory (ROM), programmable ROM (PROM), electrically programmable ROM (EPROM), electrically erasable ROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, including single-processor or multiprocessor computer systems, mini-computing devices, mainframe computers, as well as personal computers, hand-held computing devices (e.g., PDA, phone, watch, tablet computers, netbook computers, . . . ), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

FIG. 10 illustrates a block diagram of a computing system 1000 operable to execute the disclosed systems and methods in accordance with an embodiment. Computer 1012, which can be, for example, part of the hardware of a mobile reporting component or UE (e.g., component 250, etc.), a RAN component, a response component (e.g., 110, 210, and 310), etc., includes a processing unit 1014, a system memory 1016, and a system bus 1018. System bus 1018 couples system components including, but not limited to, system memory 1016 to processing unit 1014. Processing unit 1014 can be any of various available processors. Dual microprocessors and other multiprocessor architectures also can be employed as processing unit 1014.

System bus 1018 can be any of several types of bus structure(s) including a memory bus or a memory controller, a peripheral bus or an external bus, and/or a local bus using any variety of available bus architectures including, but not limited to, Industrial Standard Architecture (ISA), Micro-Channel Architecture (MSA), Extended ISA (EISA), Intelligent Drive Electronics, VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1194), and Small Computer Systems Interface (SCSI).

System memory 1016 can include volatile memory 1020 and nonvolatile memory 1022. A basic input/output system (BIOS), containing routines to transfer information between elements within computer 1012, such as during start-up, can be stored in nonvolatile memory 1022. By way of illustration, and not limitation, nonvolatile memory 1022 can include ROM, PROM, EPROM, EEPROM, or flash memory. Volatile memory 1020 includes RAM, which acts as external cache memory. By way of illustration and not limitation, RAM is available in many forms such as SRAM, dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM).

Computer 1012 can also include removable/non-removable, volatile/non-volatile computer storage media. FIG. 10 illustrates, for example, disk storage 1024. Disk storage 1024 includes, but is not limited to, devices like a magnetic disk drive, floppy disk drive, tape drive, flash memory card, or memory stick. In addition, disk storage 1024 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1024 to system bus 1018, a removable or non-removable interface is typically used, such as interface 1026.

Computing devices typically include a variety of media, which can include computer-readable storage media or communications media, which two terms are used herein differently from one another as follows.

Computer-readable storage media can be any available storage media that can be accessed by the computer and includes both volatile and nonvolatile media, removable and non-removable media. By way of example, and not limitation, computer-readable storage media can be implemented in connection with any method or technology for storage of information such as computer-readable instructions, program modules, structured data, or unstructured data. Computer-readable storage media can include, but are not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or other tangible and/or non-transitory media which can be used to store desired information. Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

It can be noted that FIG. 10 describes software that acts as an intermediary between users and computer resources described in suitable operating environment 1000. Such software includes an operating system 1028. Operating system 1028, which can be stored on disk storage 1024, acts to control and allocate resources of computer system 1012. System applications 1030 take advantage of the management of resources by operating system 1028 through program modules 1032 and program data 1034 stored either in system memory 1016 or on disk storage 1024. It is to be noted that the disclosed subject matter can be implemented with various operating systems or combinations of operating systems.

A user can enter commands or information into computer 1012 through input device(s) 1036. As an example, mobile reporting component 250 can include a user interface embodied in a touch sensitive display panel allowing a user to interact with computer 1012. Input devices 1036 include, but are not limited to, a pointing device such as a mouse, trackball, stylus, touch pad, keyboard, microphone, joystick, game pad, satellite dish, scanner, TV tuner card, digital camera, digital video camera, web camera, cell phone, smartphone, tablet computer, etc. These and other input devices connect to processing unit 1014 through system bus 1018 by way of interface port(s) 1038. Interface port(s) 1038 include, for example, a serial port, a parallel port, a game port, a universal serial bus (USB), an infrared port, a Bluetooth port, an IP port, or a logical port associated with a wireless service, etc. Output device(s) 1040 use some of the same type of ports as input device(s) 1036.

Thus, for example, a USB port can be used to provide input to computer 1012 and to output information from computer 1012 to an output device 1040. Output adapter 1042 is provided to illustrate that there are some output devices 1040 like monitors, speakers, and printers, among other output devices 1040, which use special adapters. Output adapters 1042 include, by way of illustration and not limitation, video and sound cards that provide means of connection between output device 1040 and system bus 1018. It should be noted that other devices and/or systems of devices provide both input and output capabilities such as remote computer(s) 1044.

Computer 1012 can operate in a networked environment using logical connections to one or more remote computers, such as remote computer(s) 1044. Remote computer(s) 1044 can be a personal computer, a server, a router, a network PC, cloud storage, cloud service, a workstation, a microprocessor based appliance, a peer device, or other common network node and the like, and typically includes many or all of the elements described relative to computer 1012.

For purposes of brevity, only a memory storage device 1046 is illustrated with remote computer(s) 1044. Remote computer(s) 1044 is logically connected to computer 1012 through a network interface 1048 and then physically connected by way of communication connection 1050. Network interface 1048 encompasses wire and/or wireless communication networks such as local-area networks (LAN) and wide-area networks (WAN). LAN technologies include Fiber Distributed Data Interface (FDDI), Copper Distributed Data Interface (CDDI), Ethernet, Token Ring and the like. WAN technologies include, but are not limited to, point-to-point links, circuit-switching networks like Integrated Services Digital Networks (ISDN) and variations thereon, packet switching networks, and Digital Subscriber Lines (DSL). As noted below, wireless technologies may be used in addition to or in place of the foregoing.

Communication connection(s) 1050 refer(s) to hardware/software employed to connect network interface 1048 to bus 1018. While communication connection 1050 is shown for illustrative clarity inside computer 1012, it can also be external to computer 1012. The hardware/software for connection to network interface 1048 can include, for example, internal and external technologies such as modems, including regular telephone grade modems, cable modems and DSL modems, ISDN adapters, and Ethernet cards.

The above description of illustrated embodiments of the subject disclosure, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the disclosed subject matter has been described in connection with various embodiments and corresponding Figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor may also be implemented as a combination of computing processing units.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can include both volatile and nonvolatile memory.

As used in this application, the terms “component,” “system,” “platform,” “layer,” “selector,” “interface,” and the like are intended to refer to a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can include a processor therein to execute software or firmware that confers at least in part the functionality of the electronic components.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form.

Moreover, terms like “user equipment (UE),” “mobile station,” “mobile,” subscriber station,” “subscriber equipment,” “access terminal,” “terminal,” “handset,” and similar terminology, refer to a wireless device utilized by a subscriber or user of a wireless communication service to receive or convey data, control, voice, video, sound, gaming, or substantially any data-stream or signaling-stream. The foregoing terms are utilized interchangeably in the subject specification and related drawings. Likewise, the terms “access point (AP),” “base station,” “Node B,” “evolved Node B (eNode B),” “home Node B (HNB),” “home access point (HAP),” and the like, are utilized interchangeably in the subject application, and refer to a wireless network component or appliance that serves and receives data, control, voice, video, sound, gaming, or substantially any data-stream or signaling-stream to and from a set of subscriber stations or provider enabled devices. Data and signaling streams can include packetized or frame-based flows.

Additionally, the terms “core-network”, “core”, “core carrier network”, “carrier-side”, or similar terms can refer to components of a telecommunications network that typically provides some or all of aggregation, authentication, call control and switching, charging, service invocation, or gateways. Aggregation can refer to the highest level of aggregation in a service provider network wherein the next level in the hierarchy under the core nodes is the distribution networks and then the edge networks. UEs do not normally connect directly to the core networks of a large service provider but can be routed to the core by way of a switch or radio area network. Authentication can refer to determinations regarding whether the user requesting a service from the telecom network is authorized to do so within this network or not. Call control and switching can refer determinations related to the future course of a call stream across carrier equipment based on the call signal processing. Charging can be related to the collation and processing of charging data generated by various network nodes. Two common types of charging mechanisms found in present day networks can be prepaid charging and postpaid charging. Service invocation can occur based on some explicit action (e.g. call transfer) or implicitly (e.g., call waiting). It is to be noted that service “execution” may or may not be a core network functionality as third party network/nodes may take part in actual service execution. A gateway can be present in the core network to access other networks. Gateway functionality can be dependent on the type of the interface with another network.

Furthermore, the terms “user,” “subscriber,” “customer,” “consumer,” “prosumer,” “agent,” and the like are employed interchangeably throughout the subject specification, unless context warrants particular distinction(s) among the terms. It should be appreciated that such terms can refer to human entities or automated components (e.g., supported through artificial intelligence, as through a capacity to make inferences based on complex mathematical formalisms), that can provide simulated vision, sound recognition and so forth.

Aspects, features, or advantages of the subject matter can be exploited in substantially any, or any, wired, broadcast, wireless telecommunication, radio technology or network, or combinations thereof. Non-limiting examples of such technologies or networks include Geocast technology; broadcast technologies (e.g., sub-Hz, ELF, VLF, LF, MF, HF, VHF, UHF, SHF, THz broadcasts, etc.); Ethernet; X.25; powerline-type networking (e.g., PowerLine AV Ethernet, etc.); femto-cell technology; Wi-Fi; Worldwide Interoperability for Microwave Access (WiMAX); Enhanced General Packet Radio Service (Enhanced GPRS); Third Generation Partnership Project (3GPP or 3G) Long Term Evolution (LTE); 3GPP Universal Mobile Telecommunications System (UMTS) or 3GPP UMTS; Third Generation Partnership Project 2 (3GPP2) Ultra Mobile Broadband (UMB); High Speed Packet Access (HSPA); High Speed Downlink Packet Access (HSDPA); High Speed Uplink Packet Access (HSUPA); GSM Enhanced Data Rates for GSM Evolution (EDGE) Radio Access Network (RAN) or GERAN; UMTS Terrestrial Radio Access Network (UTRAN); or LTE Advanced.

What has been described above includes examples of systems and methods illustrative of the disclosed subject matter. It is, of course, not possible to describe every combination of components or methods herein. One of ordinary skill in the art may recognize that many further combinations and permutations of the claimed subject matter are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

What is claimed is:

1. A system, comprising:
at least one memory that stores computer-executable instructions;
at least one processor, communicatively coupled to the at least one memory, that facilitates execution of the computer-executable instructions to at least:
access radio area network information associated with a change in a characteristic of a coverage area of a radio area network;
determine an adaptation response, based on the change in the characteristic of the coverage area, to facilitate adaptation of the coverage area of the radio area network, wherein the adaptation response includes an adaptation of at least one characteristic of a first antenna of the radio area network; and
facilitate access to the adaptation response.

2. The system of claim 1, wherein the radio area network information includes location information correlated to the characteristic of the coverage area of the radio area network.

3. The system of claim 2, wherein the location information and the characteristic of the coverage area are related to a position of user equipment in the coverage area of the radio area network.

4. The system of claim 3, wherein the location information is timed fingerprint location information.

5. The system of claim 3, wherein the characteristic of the coverage area is received signal strength indicator information.

6. The system of claim 1, wherein the adaptation of the at least one characteristic of the first antenna includes an update of an azimuth characteristic.

7. The system of claim 1, wherein the adaptation of the at least one characteristic of the first antenna includes an update of an elevation characteristic.

8. The system of claim 7, wherein the update of the elevation characteristic updates an electronic elevation.

9. The system of claim 1, wherein the adaptation of the at least one characteristic of the first antenna includes an update of a carrier-channel power characteristic.

10. The system of claim 1, wherein the adaptation response further includes an adaptation of at least one characteristic of a second antenna of the radio area network.

11. The system of claim 1, further comprising:
the first antenna of the radio area network, wherein the first antenna is configured to adapt the at least one characteristic of the first antenna in response to an access of the adaptation response by the first antenna.

12. The system of claim 1, wherein the change in the characteristic of the coverage area is a scheduled change.

13. The system of claim 12, wherein the scheduled change is a transition between an in-service status and an out-of-service status for a NodeB of the radio area network.

14. The system of claim 1, wherein the change in the characteristic of the coverage area is an unscheduled change.

15. The system of claim 14, wherein the unscheduled change is a transition between an in-service status and an out-of-service status for a NodeB of the radio area network.

16. A method, comprising:
accessing, by a system including at least one processor, radio area network information correlated to a change in a characteristic of a coverage area of a radio area network;
determining, by the system, a set of correction factors, based on the change in the characteristic of the coverage area of the radio area network information, to facilitate adapting the coverage area of the radio area network, wherein the set of correction factors includes an adjustment of at least one parameter of an antenna of the radio area network; and
facilitating access, by the system, to the set of correction factors.

17. The method of claim 16, wherein the accessing the radio area network information includes accessing information that is related to a position of user equipment in the coverage area of the radio area network, and comprises timed fingerprint location information and received signal strength indicator information.

18. The method of claim 16, wherein the accessing the radio area network information includes accessing the radio area network information correlated to a planned change in the characteristic of the coverage area of the radio area network information.

19. The method of claim 16, wherein the accessing the radio area network information includes accessing the radio area network information correlated to an unplanned change in the characteristic of the coverage area of the radio area network information.

20. A mobile device, comprising:
at least one memory that stores computer-executable instructions;
at least one processor, communicatively coupled to the at least one memory, that facilitates execution of the computer-executable instructions to at least:
determine timed fingerprint location information of the mobile device in a coverage area of a radio area network;
determine a change in a characteristic of the coverage area of the radio network;
determine privacy-protected information based on application of a predetermined privacy criterion to the determined timed fingerprint location information and the determined change in the characteristic; and
facilitate access to the privacy-protected information by a remote computing component, wherein the remote computing component facilitates determination of an adaptation response based on the privacy-protected information, to facilitate an adaptation of the coverage area of the radio area network, including an adaptation of at least one characteristic of an antenna of the radio area network.
